(19) United States
(12) Patent Application Publication
(10) Pub. No.: US 2023/0064824 A1
(43) Pub. Date: Mar. 2, 2023

(54) SYSTEM AND METHOD FOR IMPLEMENTING A RESEARCH AND DEVELOPMENT TAX CREDIT TOOL

(71) Applicant: KPMG LLP, New York, NY (US)

(72) Inventors: Ajay WANCHOO, Bernardsville, NJ (US); Chaitanyasinh EJNER, Kearny, NJ (US); Kate MARINKOVICH, Brooklyn, NY (US); Arjun REKHI, New York, NY (US)

(21) Appl. No.: 17/895,825

(22) Filed: Aug. 25, 2022

Related U.S. Application Data
(60) Provisional application No. 63/236,908, filed on Aug. 25, 2021.

(51) Int. Cl. G06Q 40/00

(52) U.S. Cl. CPC G06Q 40/123

(57) ABSTRACT

An embodiment of the present invention is directed to an Agile Research and Development (R&D) Analyzer that represents a suite of tools that analyze documentation and associated metadata from project management systems such as JIRA, Wiki, and GIT to assist in key stages of a qualitative assessment of an R&D Tax Credit Study. The quantitative assessment may be leveraged across a number of entities and clients that use Agile software development processes or other iterative approach to project management and software development. For example, the Agile R&D Analyzer may be used by Tax engagement team members during a R&D Tax Credit Study.

### CROSS-REFERENCE TO RELATED APPLICATION

This application claims priority to U.S. Provisional Application Ser. No. 63/236,908 (Attorney Docket No. 55089.000061), filed Aug. 25, 2021, the contents of which are incorporated by reference herein in their entirety.

### FIELD OF THE INVENTION

The present invention relates to systems and methods for implementing a research and development (R&D) tax credit assessment tool.

### BACKGROUND

Entities operating across various industries may benefit from research and development (R&D) tax credits per Internal Revenue Code Section 41. For example, if an entity invests in qualified research activities, a tax credit may be available. Qualified research activities may include internal software solutions and applications as well as various technology advancements. To claim the tax credit, an entity will perform a study that involves identifying, documenting and supporting eligible expenses associated with qualified R&D activities. A thorough R&D analysis and gathering of supporting documentation is therefore needed to properly claim the R&D credits.

The eligibility and documentation requirements are extensive and complex. In addition, there are penalties for improper filings. Claiming the R&D tax credit with improper supporting evidence is risky and costly. The current process is burdensome and manual in nature without clear guidance on a common acceptable form or template.

Modern software development delivery involves lean practices with no formal tracking of engineering personnel and lack of technical documentation. These lean processes are not designed to support the requirements for conducting Section 41 R&D studies and thereby creates significant inefficiencies.

It would be desirable, therefore, to have a system and method that could overcome the foregoing disadvantages of known systems.

### SUMMARY

According to an embodiment, the invention relates to a computer-implemented system that implements a research and development analyzer tool. The system comprises: an interface that is configured to access a plurality of data sources; a memory component that stores and manages data relating to research and development assessment; and a computer processor coupled to the interface and the memory component, the computer processor further configured to perform the steps of: extracting, via the interface, data from the plurality of data sources, wherein the data comprises project data, human resource data and vendor data related to a project; transforming, via the computer processor, the data to generate an activity nexus matrix, a subject matter expert identification component and business identification component in a standardized output format; based on the standardized output format, generating, via a recommendation engine, one or more interview preparation packages and pre-qualified time survey data for the project; based on the one or more interview preparation packages and pre-qualified time survey data, initiating a validation session with one or more subject matter experts; and generating a credit calculation with contemporaneous technical documentation supporting a research and development credit for the project.

According to another embodiment, the invention relates to a computer-implemented method that implements a research and development analyzer tool. The method comprises the steps of: extracting, via an interface, data from the plurality of data sources, wherein the data comprises project data, human resource data and vendor data related to a project; transforming, via a computer processor, the data to generate an activity nexus matrix, a subject matter expert identification component and business identification component in a standardized output format; based on the standardized output format, generating, via a recommendation engine, one or more interview preparation packages and pre-qualified time survey data for the project; based on the one or more interview preparation packages and pre-qualified time survey data, initiating a validation session with one or more subject matter experts; and generating a credit calculation with contemporaneous technical documentation supporting a research and development credit for the project.

Benefits include substantial reduction of time, resources and effort in performing R&D credit assessment. An embodiment of the present invention achieves improved accuracy in data collection and efficiency through a streamlined process.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary system diagram, according to an embodiment of the present invention.

FIG. 2 is an exemplary system diagram, according to an embodiment of the present invention.

FIG. 3 is an exemplary system diagram, according to an embodiment of the present invention.

FIG. 4 is an exemplary diagram illustrating data transformation, according to an embodiment of the present invention.

FIG. 5 is a flowchart for generating an activity nexus matrix, according to an embodiment of the present invention.

FIG. 6 is a flowchart for SME identification analysis, according to an embodiment of the present invention.

FIG. 7 is a flowchart for an interview preparation package, according to an embodiment of the present invention.

FIG. 8 is a flowchart for time survey, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to an Agile Research and Development (R&D) Analyzer that represents a suite of tools that analyze documentation and associated metadata from project management systems such as JIRA, Wiki, and GIT to assist in key stages of a qualitative assessment of an R&D Tax Credit Study. The quantitative assessment may be leveraged across a number of entities and clients that use Agile software development processes or other iterative approach to project management and software development. For example, the Agile R&D Analyzer may be used by Tax engagement team members during a R&D Tax Credit Study. In addition, a client may provide metadata via Excel, CSV, and/or JSON that may be processed through various models.

The suite of tools may be customized to support various applications, use cases and industries. In addition, the suite of tools may further support automated data extraction and preliminary analysis; linking people to projects using metadata captured in real-time which provides support for high risk Qualified Research Expenditures (QRE) (e.g., highly compensated employees), Internal Use Software (IUS); reduction of number of interviews required while maximizing coverage of Qualified Research Activities (QRA), providing focus for interviews thereby reducing or eliminating SME preparation and reducing duration of interviews. An embodiment of the present invention further provides real-time visualization of key insights through custom dashboards and/or other interfaces.

An embodiment of the present invention is directed to extracting data from client documentation stored and managed in repositories, document management tools, project management systems, etc. An embodiment of the present invention may access various repositories, track software development and other activity (e.g., what features are being built, what software is being written, etc.), and gather metadata and corresponding content. The extracted data may be processed through statistical analysis to accurately identify a level of activity by each participant, estimated time of investment and/or other metrics on a project, matter or user basis. For example, this may involve analyzing the number of entries, lines of code and/or other activity performed.

An embodiment of the present invention may identify subject matter experts (SMEs), direct support R&D employees and other participants in projects. The innovative system also creates interview preparation packages and pre-populates a time survey to pre-qualify activities for R&D credits. Interview preparation packages may be used with SMEs to learn more about projects and determine whether the projects qualify for R&D credits. The time survey may provide time spent details that are generally needed to qualify the activity for credit and further assess the value of the credit. With an embodiment of the present invention, SMEs may validate data and approve the pre-calculated time surveys.

Interview preparation packages may include summarized documentation sourced from the original detailed documentation and prioritized based on relevance to the interviewee and/or project based on the intensity and nature of activity on the body of work under consideration during an interview. These may be interview aides used by an interviewer to facilitate the direction and focus of an interview.

Other embodiments may include standardizing the employee job title/role scoring algorithm and weighting methodology; developing standardized dashboards to present insights and identifying new features to include to support Intellectual Property (IP) evaluation studies, for example.

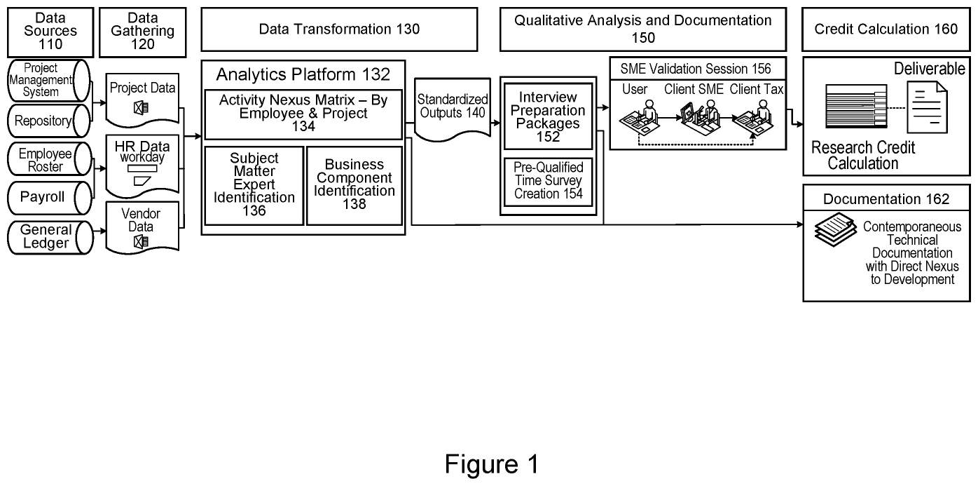

FIG. 1 is an exemplary system diagram, according to an embodiment of the present invention. FIG. 1 illustrates various stages of an assessment process including Data Sources 110, Data Gathering 120, Data Transformation 130, Qualitative Analysis and Documentation 150 and Credit Calculation 160. Data Sources 110 may include project management systems (e.g., JIRA, Trello, Rally, etc.), versioning control software repositories (e.g., GitHub), Employee Roster, Payroll, General Ledger (or other record keeping system), for example. Data Gathering 120 may extract various types of data including Project Data, human resources (HR) data and Vendor Data.

Data Transformation 130 may include Analytics Platform 132 that generates activity nexus matrix by employee, project, etc., as shown by 134. Data Transformation 130 may further identify subject matter experts via 136, and business components via 138, which identifies potentially qualifying R&D projects. An embodiment of the present invention recognizes that personnel titles are not entirely reflective of actual activity. In addition, in most large organizations, many individuals may have varying involvement in different phases of a project.

Business component identification may be performed by a Business Components Recommendation Engine. An embodiment of the present invention may ingest raw activity data from a taxpayer's internal activity tracking system (e.g., JIRA, Asana, GitHub, Trello, etc.) and suggest business components using ML/NLP/text pattern recognition against the data. For example, the Recommendation Engine may compare development activity data against a training set containing activity data/business components which were upheld during an audit defense to identify strong business components. Further, the Recommendation Engine may suggest clustering and other criteria to group the business components together based on ML techniques to suggest business components which have a strong chance to be upheld during a potential audit.

Data may be outputted in various formats including standardized outputs 140 as well as other documentation 162 including contemporaneous technical documentation with a direct nexus to development. An embodiment of the present invention recognizes that technology documents are not written with Section 41 in mind. Moreover, documents written for business cases, budgetary approvals and progress reports in the normal course of business do not highlight facts and information needed. Oftentimes, project documentation is scattered across the organization which leads to expending time and effort to obtain the necessary information.

Qualitative Analysis and Documentation 150 may generate Interview Preparation Packages 152 and Pre-Qualified Time Survey Creation via 154. SME Validation Session 156 may be performed by various participants, including Users, Client SME and Client Tax representatives. Credit Calculation 160 may generate various outputs including Research Credit Calculation and other deliverables. For example, deliverables may include a list of qualifying projects, project time surveys, project QRE, project narratives including snapshots and questionnaires, file of sample contemporaneous documentation gathered and workstream process design flowchart.

An embodiment of the present invention may implement a Technical Interview Topic Recommendation Engine that uses ML/NLP/text pattern recognition techniques to recommend technical interview topics in order to introduce efficiencies in the tax credit study along with reducing the user's overall footprint on the taxpayer (e.g., reducing technical interview durations). The Technical Interview Topic Recommendation Engine may ingest raw activity data from a taxpayer's internal activity tracking system (e.g., JIRA, Asana, GitHub, Trello, etc.) and output an activity overview, which the user may leverage during technical interviews.

An embodiment of the present invention is directed to an adaptive solution for Agile development that analyzes the metadata captured in real-time during the credit year (or other time period) in various repositories (e.g., JIRA repositories, versioning control software repositories, etc.) to pre-qualify projects, identify SME(s) and prepare targeted materials for focused interviews.

Pre-qualifications increase efficiencies by reducing the number of interviews and follow-ups; improve coverage of qualifying activities and provide a refined statistical sample. Interviewers are better prepared with the most active development activities. In addition, interviews are more targeted and focused with recommended technical facts to validate qualifications. Additional benefits include less or minimal preparation needed by SMEs, shorter interviews if deemed necessary, non-obvious direct support QRE; preemptive confirmation of high-risk contributors and real-time visualization of key insights.

An embodiment of the present invention provides relevant technical document identification and classification per Section 41 four-part test. An exemplary multi-part test may include a general four part test applied as detailed in section 41(d) and Treas. Reg. § 1.41-4(a). In this example, “qualified research” activities must satisfy the following requirements of a four-part test: (1) Permitted Purpose; (2) Technological in Nature; (3) Elimination of Uncertainty/Section 174 Expenses; and (4) Process of Experimentation. The four-part test is one example and other requirements and/or tests may be applied.

Questionnaires and technical narratives may be pre-populated to streamline and facilitate the process and further support robust quality documentation. In addition, targeted facts may be highlighted in technical write-ups. Other benefits include shorter time to capture, collate and write-up documentation; support for high risk QREs and improved consistency across processes with real-time quality assessment.

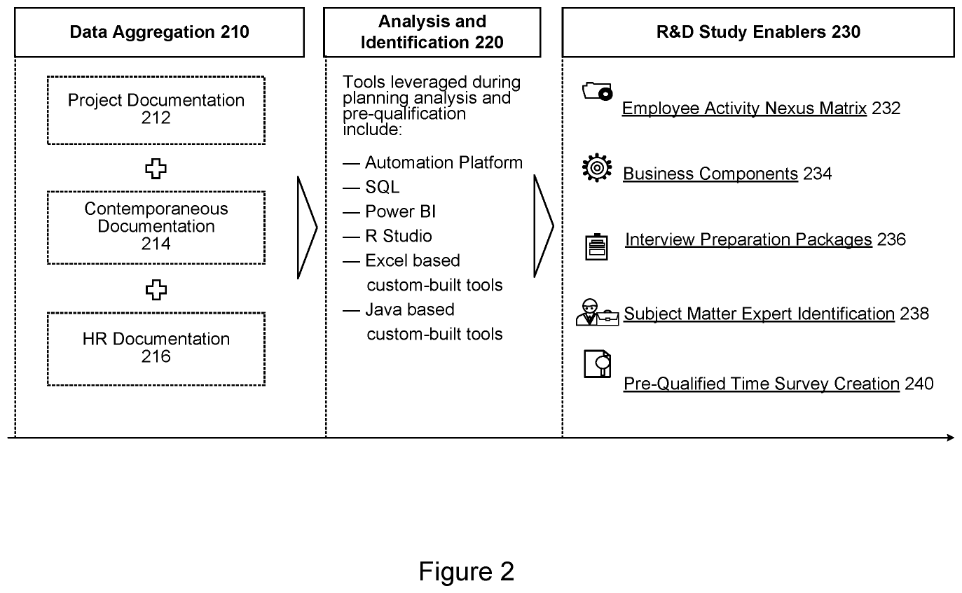

FIG. 2 is an exemplary system diagram, according to an embodiment of the present invention. An embodiment of the present invention is directed to analyzing documentation and associated metadata from systems such as JIRA, Wiki and GIT to assist in key stages of a qualitative assessment. The data is gathered in real-time from a company's systems and leveraged across various clients, systems and applications that use Agile processes.

As shown in FIG. 2, an embodiment of the present invention may support Data Aggregation 210, Analysis and Identification 220 and R&D Study Enablers 230. Data Aggregation 210 may aggregate data from sources including Project Documentation 212, Contemporaneous Documentation 214 and HR Documentation 216. The aggregated data may then be analyzed by Analysis and Identification 220 which may include tools leveraged during planning analysis and pre-qualification. R&D Study Enablers 230 may include Employee Activity Nexus Matrix 232, Business Components 234, Interview Preparation Packages 236, Subject Matter Expert Identification 238 and Pre-Qualified Time Survey Creation 240.

Employee Activity Nexus Matrix 232 may create contemporaneous documents at an employee level. Business Components 234 may identify potentially qualifying R&D projects without going back and forth with clients. Interview Preparation Packages 236 reduce interview time and lower footprint on client teams as project information may be obtained beforehand. Subject Matter Expert Identification 238 refines the search for identifying the project contacts and reduces footprint on the client. Pre-Qualified Time Survey Creation 240 quantifies employee time and reduces effort spent by employees on timesheets.

An embodiment of the present invention is directed to developing and deploying advanced analytics to ingest and analyze large volumes of unstructured content and metadata; identifying and pre-qualifying business components and teams; and automatically generating and prepopulating time surveys.

An embodiment of the present invention seeks to maximize use of available data, technical documentation and back-office systems. The innovative system ensures pertinent information is recorded in real-time and more accurate estimates are available for provision and other estimates and tasks.

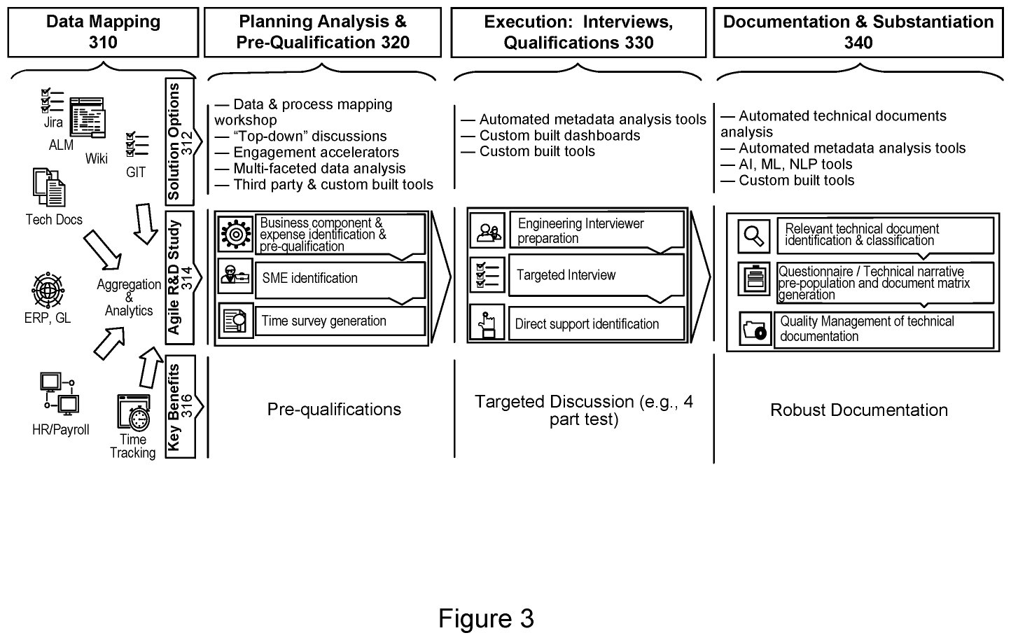

FIG. 3 is an exemplary system diagram, according to an embodiment of the present invention. FIG. 3 illustrates Data Mapping 310, Planning Analysis and Pre-Qualification 320, Execution: Interviews, Qualifications 330 and Documentation and Substantiation 340.

Data Mapping 310 is directed to aggregating and analyzing data from various sources, as shown in FIG. 1. An embodiment of the present invention is directed to developing a workflow for automatically extracting metadata from management tools and systems and performing data quality checks. The aggregated data may be used to develop Solution Options 312, Agile R&D Study 314 and Key Benefits 316 at various stages.

Planning Analysis and Pre-Qualification 320 may support data and process mappings, top-down discussions to engage technology leadership, key data stewards and lead architects. Other solution options may include engagement accelerators (e.g., data extraction, data quality checks, etc.); multi-faceted data analysis and third party and custom built tools. Agile R&D Study may support business component and expense identification and pre-qualification; SME identification and time survey generation.

Key Benefits may be realized through pre-qualifications that increase efficiencies by reducing number of interviews and follow-ups; improved coverage of qualifying activities and refined statistical sample.

Execution: Interviews, Qualifications 330 may support automated metadata analysis tools in case actual technical documentation cannot be made available. Other solution options may include custom built dashboards that provide KPI insights including key QRE contributors and study progress as well as other custom built tools. Agile R&D Study may support engineering interviewer preparation with most active development activities; targeted interview with recommended technical facts to validate qualification and direct support identification.

Key benefits may include targeted discussion (e.g., four part test discussion) with less or minimal preparation needed by SMEs; shorter interviews if necessary; non-obvious direct support QRE; preemptive confirmation of high risk contributors and real-time visualization of key insights. For example, targeted interviews may seek to corroborate analysis and findings.

Documentation and Substantiation 340 may support automated technical documents analysis by industry trained software engineers. Other solution options may include automated metadata analysis tools in case technical content cannot be made available; AI, ML, NLP tools that assess quality of write-ups and other custom built tools. Agile R&D Study may support relevant technical document identification and classification per Section 41 four part test; questionnaire/technical narrative pre-population and document matrix generation and quality management of technical documentation.

Key benefits may include robust documentation with targeted facts highlighted in technical write-ups; shorter time to capture, collate and write-up; support for high risk QREs (e.g., highly compensated employees, IUS) and consistency across processes with real-time quality assessment.

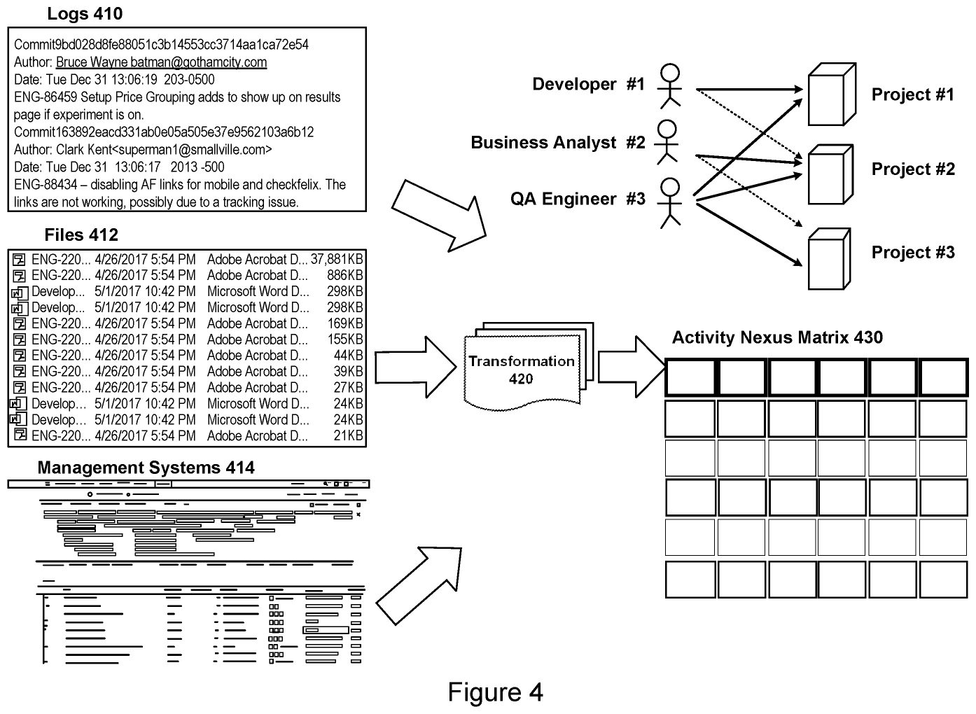

FIG. 4 is an exemplary diagram illustrating data transformation, according to an embodiment of the present invention. An embodiment of the present invention is directed to deriving the nexus from documentation and/or other sources.

As shown in FIG. 4, data may be extracted from various sources, including logs 410 (e.g., GIT logs), files 412 (e.g., text, word, PDF, etc.) and management systems 414 (e.g., JIRA). Other data sources may include resource and wage information, issue logs, wiki documentation, etc. The extracted data may be transformed by running a series of filters, based on the various fields of the JIRA (or similar datasets) including, but not limited to, Issue ID, Time stamp, Project/Initiative, Summary, Details, Assignee, Reporter, and other fields to filter relevant time periods, issue types, teams, projects and/or other R&D Credit pertinent criteria that enables the engagement team to align the scope of the data analysis with the overall R&D Credit Study objectives and scope. Subsequent analysis may include, if the data is readily available, certain other operations to enrich the available data by “joining” (in the SQL sense, similar to a vlookup in Excel) data from other data sources, including but not limited to, Human Resources (HR) that may provide additional information regarding the employee details which in turn may help refine the dataset with additional filter criteria, such as location, wages, job title, etc. This may be followed by a summarization, a pivot (in Excel) or “group by” (similar to group by function in the database programming language SQL) of issues by information including project teams or users assigned to various issues, user stories or similar (as used in JIRA). Depending on the manner in which additional detail is available, further refinements, mapping and/or grouping of issues or projects may be applied. This analysis may then be used to create a table in which each employee or contractor mentioned in the JIRA or similar data set provided as input, is listed along with a series of numbers against each project they were associated with, wherein the numbers indicate the level of intensity or activity the employee or contractor was mentioned against a project, initiative and/or any similar construct leveraged to indicate a Business Component (as used in the context of R&D Credit Studies). This matrix that creates a map of each employee or contractor and the project they worked on may be referred to as an Activity Nexus Matrix 430.

The transformation process, as shown by 420, may involve joining and normalizing data using custom scripts. For example, software activity may be reported by showing relative activity by project, activity by person, person-to-project nexus, activity timeline, etc. Other summary visualizations and reporting may be supported. An embodiment of the present invention recognizes that projects involve various participants such as developers, business analysts, QA engineers, etc.

An embodiment of the present invention may further customize workflows and extend capabilities, including building out standard processes to group projects (e.g., JIRA and GIT projects) and performing year-over-year analysis to target new/growing development efforts and minimize reliance on client resources. In addition, team composition may be summarized by role for each project and identify NQ/non-technical programs. For example, Project A has 9 Data Engineers, 3 Software Engineers, a Quality Assurance Engineer, and 1 PM=Likely Potentially Qualifying or “PQ”. According to another example, Project B has 5 Customer Service Analysts, 2 Business/Finance Consultants, and 1 PM=Likely Non-Qualifying or “NQ”.

Nexus Matrix Reports may include various formats and views. For example, a Wage QRE Report view may include the following: Employee; Title; Activity Summary (JIRA—Reporter); Activity Summary (GIT); Wages; Qualification Percentage (e.g., estimating qualification percentage through JIRA and/or GIT activity); Wage QRE. The Wage QRE Report may consolidate entries and summarize by resource. The Wage QRE Report may further demonstrate relative activity per person and provide risk assessment qualifications based on activity level, project and/or job title.

A JIRA Activity by Project view may include the following: Business Component; JIRA Project Name; JIRA Activity; Title Activity; Unique Employee; Assignees; Reviewers and Reporters. The JIRA Activity by Project view may consolidate entries and summarize by project. The JIRA Activity by Project view may demonstrate relative activity by job title and provide risk assessment qualification based on person, project and/or job title.

A GIT Activity by Project view may include the following: Business Component; Projects; Employee Title Count; Total Employees, Net GIT Activity; number of comments. The GIT Activity by Project view may consolidate entries and summarize by resource. The GIT Activity by Project view may demonstrate relative activity per person and provide risk assessment qualification based on activity level, project and/or job title.

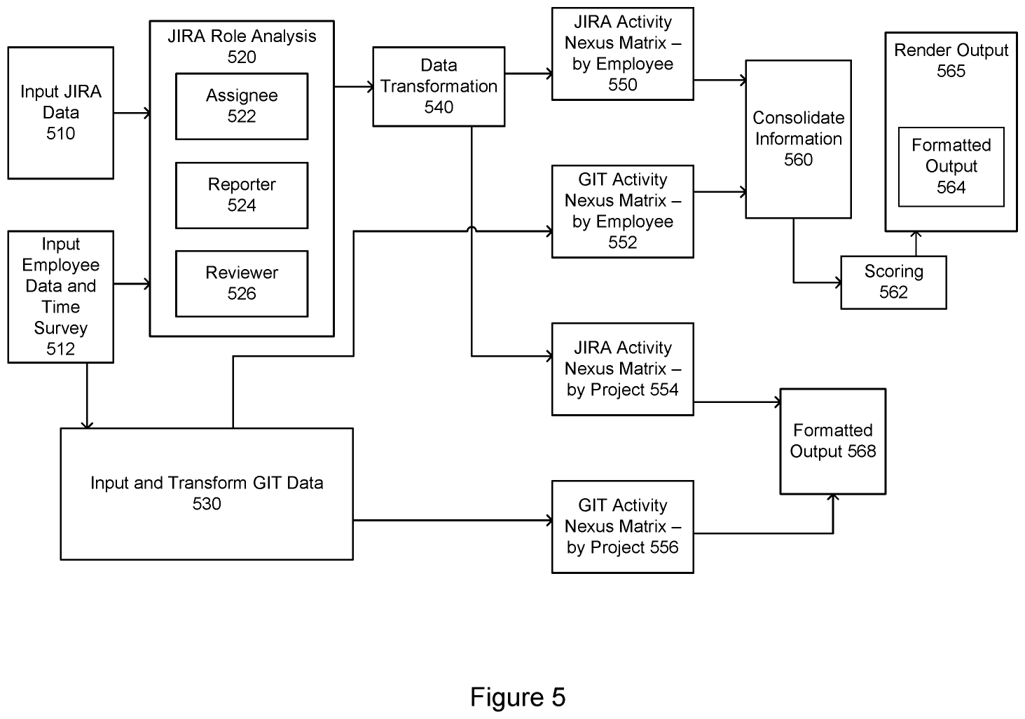

FIG. 5 is a flowchart for generating an activity nexus matrix, according to an embodiment of the present invention. Input JIRA Data 510 and Input Employee Data and Time Survey 512 may be received by JIRA Role Analysis 520, which may include Assignee 522, Reporter 524 and Reviewer 526. JIRA data may refer to issue and project tracking data according to an embodiment of the present invention. Other issue and project tracking data may be applied. Input Employee Data and Time Survey 512 data may be fed into Input and Transform GIT Data 530. GIT data may refer to version control software data. Other software change or source code management data may be supported.

JIRA Role Analysis 520 may generate data to be transformed by Data Transformation 540. The transformed data may be used to generate JIRA Activity Nexus Matrix—By Employee 550 and JIRA Activity Nexus Matrix—By Project 554.

Input and Transform GIT Data 530 may be used to generate GIT Activity Nexus Matrix—By Employee 552 and GIT Activity Nexus Matrix—By Project 556.

Data from JIRA Activity Nexus Matrix—By Employer 550 and GIT Activity Nexus Matrix—By Employee 552 may be received and consolidated at 560. Scoring may be applied at 562 and then an output may be rendered at 565 and formatted at 564. For example, the scoring formula is flexible and may represent a weighted sum of the various levels activity as indicated by JIRA, GIT or similar data extracts, as well as scores evaluated based on other parameters from other data sources, e.g., job title, number of counselees (or number of employees directly reporting to an employee), wages, number of patents, length of employment in the firm, etc.

Data from JIRA Activity Nexus Matrix—By Project 554 and GIT Activity Nexus Matrix—By Project 556 may be received and formatted at 568.

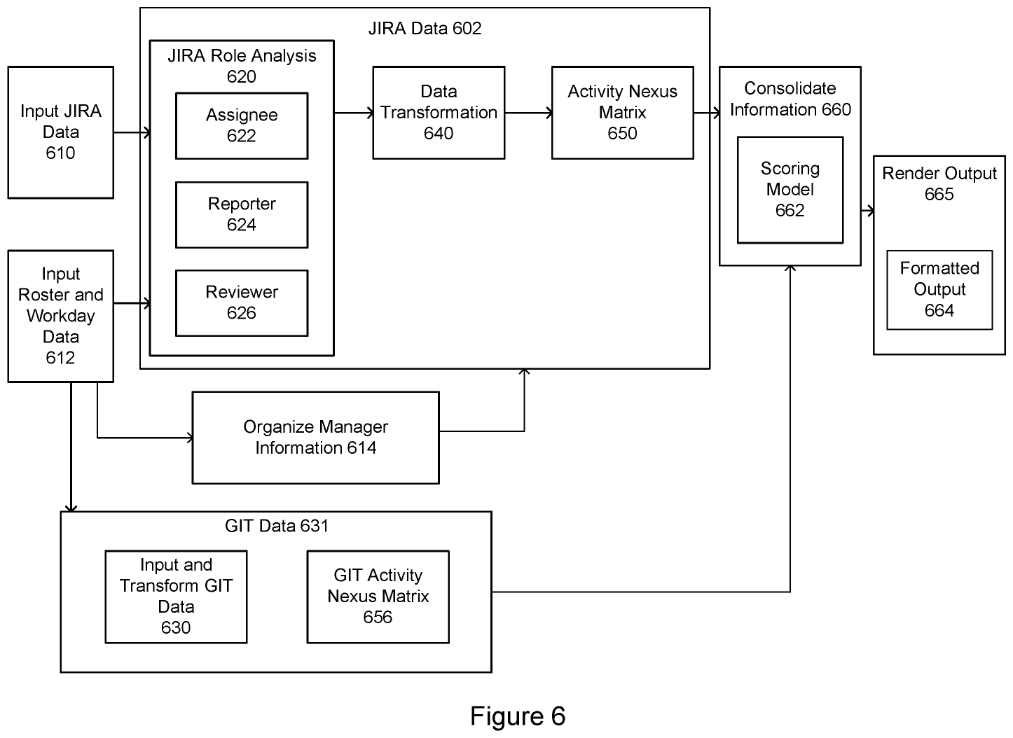

FIG. 6 is a flowchart for SME identification analysis, according to an embodiment of the present invention.

Input JIRA Data 610 and Input Roster and Workday Data 612 (e.g., employee identifier, name, username, etc.) may be received by JIRA Role Analysis 620, which may include Assignee 622, Reporter 624 and Reviewer 626. Input Roster and Workday Data 612 may be fed into GIT Data 631 which includes Input and Transform GIT Data 630 and GIT Activity Nexus Matrix 656. JIRA Role Analysis 620 may generate data to be transformed by Data Transformation 640. The transformed data may be used to generate Activity Nexus Matrix 650.

Input Roster and Workday Data 612 may be received by Organize Manager Information 614 which communicates with JIRA Data 602.

Data from Activity Nexus Matrix 650 and GIT Activity Nexus Matrix 656 may be received and consolidated at 660, which may apply a Scoring Model 662. An output may be rendered at 665 and then formatted at 664.

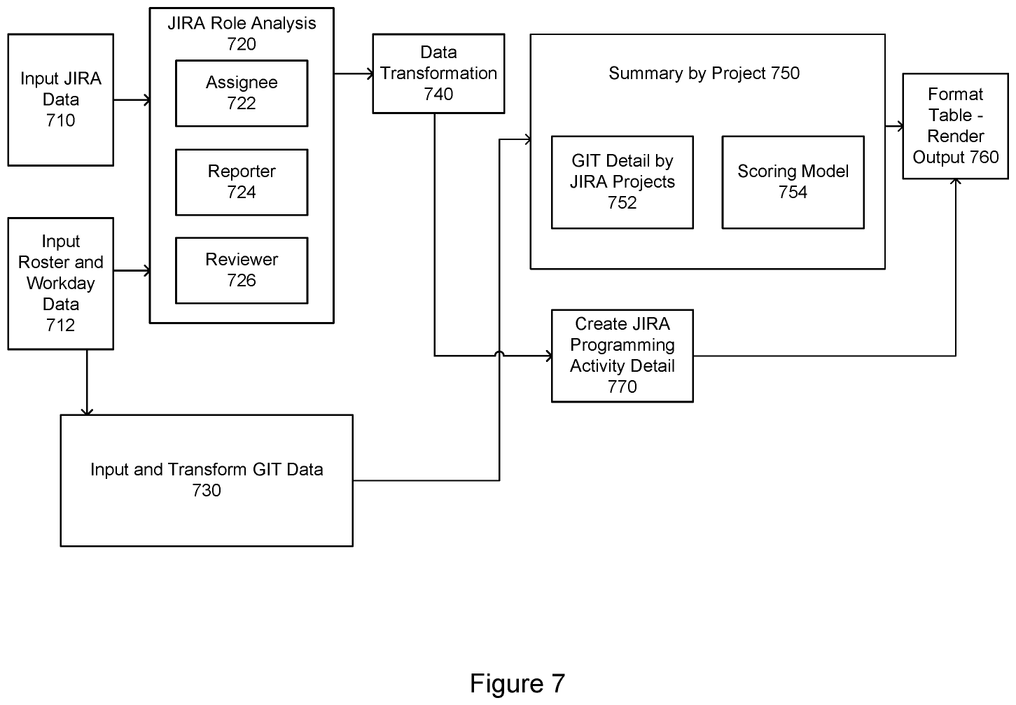

FIG. 7 is a flowchart for an interview preparation package, according to an embodiment of the present invention.

Input JIRA Data 710 and Input Roster and Workday Data 712 may be received by JIRA Role Analysis 720, which may include Assignee 722, Reporter 724 and Reviewer 726. Input Roster and Workday Data 712 may be fed into Input and Transform GIT Data 730. JIRA Role Analysis 720 may generate data to be transformed by Data Transformation 740. The transformed data may be used to Create JIRA Programming Activity Detail 770. Input and Transform GIT Data 730 may communicate with Summary by Project 750 which includes GIT Detail by JIRA Projects 752 and Scoring Model 754. An output may be rendered at 760 in table format, for example.

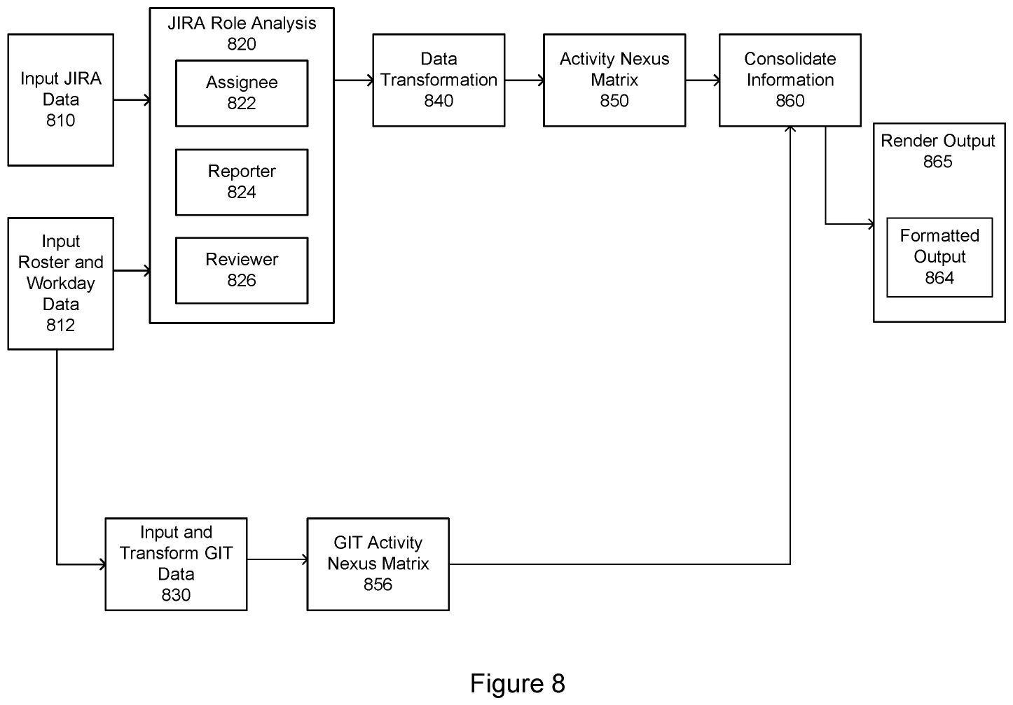

FIG. 8 is a flowchart for time survey, according to an embodiment of the present invention.

Input JIRA Data 810 and Input Roster and Workday Data 812 may be received by JIRA Role Analysis 820, which may include Assignee 822, Reporter 824 and Reviewer 826. Input Roster and Workday Data 812 may be fed into Input and Transform GIT Data 830 which then generates GIT Activity Nexus Matrix 856.

JIRA Role Analysis 820 may generate data to be transformed by Data Transformation 840. The transformed data may be used to generate Activity Nexus Matrix 850. Data from Activity Nexus Matrix 850 and GIT Activity Nexus Matrix 856 may be received and consolidated at 860.

An output may be rendered at 865 and then formatted at 864.

Time Survey output may include: workday employee identifier; name; job profile name; final assigned business component; number of commits; number of files; total GIT activity; total JIRA activity; assignee; reporter; reviewer; estimated Qualification Percentage; technical supervision; requirements: business/technical specifications; software design and architecture; programming; testing; platforms, infrastructure & support; project budgeting & resources; post production maintenance & support; operations, infrastructure & administrative support; people development & training; non-work time; qualified time; qualified time with sub-all; total time; and notes.

Qualitative Summary report may include: JIRA project key; JIRA project name; JIRA activity; Net GIT Activity; number of commits; number of files; JIRA employee count; GIT employee count; assignee count; reviewer count; reporter count; JIRA job title count; score by max; and comments.

SME identification output may include: Business Component (BC); Manager identifier; Manager's Preferred Name; Job Profile Name; Hire Date; Cost Center-Name; Manager Assigned Business Component; number of Direct Reports in BC; number of commits; number of files; total GIT activity; Total JIRA activity; assignee; reporter; reviewer and notes.

Employee Activity Nexus Matrix may include: Workday Employee Identifier; Name; Job Profile Name; Final Assigned Business Component; number of commits; number of files; total GIT Activity; total JIRA activity; assignee; reporter; reviewer; notes; score by max.

Project Activity Nexus Matrix may include: Project Key; Project Name; number of commits; number of files; total GIT activity; total JIRA activity; assignee; reporter; and reviewer.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the system software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more of them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

What is claimed is:

1. A computer-implemented system for implementing a research and development tax credit assessment tool, the system comprising:
an interface that is configured to access a plurality of data sources;
a memory component that stores and manages data relating to research and development assessment; and
a computer processor coupled to the interface and the memory component, the computer processor further configured to perform the steps of:
extracting, via the interface, data from the plurality of data sources, wherein the data comprises project data, human resource data and vendor data related to a project;
transforming, via the computer processor, the data to generate an activity nexus matrix, a subject matter expert identification component and business identification component in a standardized output format;
based on the standardized output format, generating, via a recommendation engine, one or more interview preparation packages and pre-qualified time survey data for the project;
based on the one or more interview preparation packages and pre-qualified time survey data, initiating a validation session with one or more subject matter experts; and
generating a credit calculation with contemporaneous technical documentation supporting a research and development credit for the project.

2. The system of claim 1, wherein the plurality of data sources comprise project management systems, versioning control software repositories, employee rosters and payroll systems.

3. The system of claim 1, wherein the subject matter expert identification component comprises identifying one or more proper contacts associated with one or more components of the project.

4. The system of claim 1, wherein the business identification component comprises identifying potentially qualifying research and development projects.

5. The system of claim 4, wherein the business identification is performed via a business components recommendation engine that compares development activity data against a training data set containing activity data and business components that were upheld during a prior audit defense.

6. The system of claim 1, wherein the one or more interview preparation packages are used with one or more subject matter experts to determine whether research and development credits qualify for the project.

7. The system of claim 6, wherein the interview preparation packages are generated by the recommendation engine that provides an activity overview that is leveraged during one or more technical interviews.

8. The system of claim 1, wherein the pre-qualified time survey data comprises time spent details to determine activity credit and value for the project.

9. The system of claim 1, wherein the activity nexus matrix is by employee and by project.

10. The system of claim 1, wherein the project data comprises JIRA data and GIT data.

11. A computer-implemented method for implementing a research and development tax credit assessment tool, the method comprising the steps of:
extracting, via an interface, data from the plurality of data sources, wherein the data comprises project data, human resource data and vendor data related to a project;
transforming, via a computer processor, the data to generate an activity nexus matrix, a subject matter expert identification component and business identification component in a standardized output format;
based on the standardized output format, generating, via a recommendation engine, one or more interview preparation packages and pre-qualified time survey data for the project;
based on the one or more interview preparation packages and pre-qualified time survey data, initiating a validation session with one or more subject matter experts; and
generating a credit calculation with contemporaneous technical documentation supporting a research and development credit for the project.

12. The method of claim 11, wherein the plurality of data sources comprise project management systems, versioning control software repositories, employee rosters and payroll systems.

13. The method of claim 11, wherein the subject matter expert identification component comprises identifying one or more proper contacts associated with one or more components of the project.

14. The method of claim 11, wherein the business identification component comprises identifying potentially qualifying research and development projects.

15. The method of claim 14, wherein the business identification is performed via a business components recommendation engine that compares development activity data against a training data set containing activity data and business components that were upheld during a prior audit defense.

16. The method of claim 11, wherein the one or more interview preparation packages are used with one or more subject matter experts to determine whether research and development credits qualify for the project.

17. The method of claim 16, wherein the interview preparation packages are generated by the recommendation engine that provides an activity overview that is leveraged during one or more technical interviews.

18. The method of claim 11, wherein the pre-qualified time survey data comprises time spent details to determine activity credit and value for the project.

19. The method of claim 11, wherein the activity nexus matrix is by employee and by project.

20. The method of claim 11, wherein the project data comprises JIRA data and GIT data.
